(19) United States
(12) Patent Application Publication
(10) Pub. No.: US 2018/0314027 A1
(43) Pub. Date: Nov. 1, 2018

(54) PHOTOELECTRIC COMPOSITE CABLE AND METHOD OF MANUFACTURING PHOTOELECTRIC COMPOSITE CABLE

(71) Applicant: SUMITOMO ELECTRIC INDUSTRIES, LTD., Osaka (JP)

(72) Inventors: Hiroki ISHIKAWA, Osaka (JP); Yasuhiro MAEDA, Osaka (JP); Manabu IZAKI, Osaka (JP); Takeshi INOUE, Osaka (JP)

(73) Assignee: SUMITOMO ELECTRIC INDUSTRIES, LTD., Osaka (JP)

(21) Appl. No.: 15/945,946

(22) Filed: Apr. 5, 2018

(30) Foreign Application Priority Data
Apr. 26, 2017 (JP) 2017-087280

(51) Int. Cl. G02B 6/44; H01B 11/22; H01B 7/18; H01B 13/02

(52) U.S. Cl. CPC G02B 6/4486; H01B 11/22; G02B 6/4432; H01B 13/02; H01B 7/18

(57) ABSTRACT

A photoelectric composite cable includes an optical fiber unit including at least one optical fiber and a cylindrical member, the cylindrical member including a resin tape wrapped to cover a periphery of the optical fiber, the resin tape being loosely wrapped with respect to the optical fiber, a plurality of electric wires arranged on an outer side of the cylindrical member, and a sheath covering outer peripheries of the optical fiber unit and the electric wires.

### CROSS-REFERENCE TO RELATED APPLICATION

The present application claims priority from Japanese Patent Application No. 2017-087280 filed on Apr. 26, 2017, the entire content of which is incorporated herein by reference.

### BACKGROUND

### Technical Field

The present invention relates to a photoelectric composite cable and a method of manufacturing the photoelectric composite cable.

### Related Art

Patent Document 1 discloses a photoelectric composite cable in which a plurality of optical fibers is accommodated in an inner cylindrical member, which is a resin tube, a plurality of electric wires is arranged around the inner cylindrical member, and the inner cylindrical member and the plurality of electric wires are covered. Patent Document 2 discloses an optical fiber cable in which a plurality of optical fibers is collected and a wrapping member having a tape or the like is wrapped around the optical fibers.

Patent Document 1: JP-A-2014-216176

Patent Document 2: JP-A-2005-283624

The photoelectric composite cable disclosed in Patent Document 1 has such a structure that the plurality of optical fibers is inserted in the tube made of thermoplastic resin. In this structure, the tube is required to be manufactured by extrusion molding, and a manufacturing process thereof should be performed separately from a stranding process of the electric wires. For this reason, the manufacturing cost of the photoelectric composite cable increases.

Also, according to the optical fiber cable having the wrapping member, like Patent Document 2, it is difficult to mount a connector to a terminal. Generally, in a structure where the optical fibers are wrapped and unitized by the tape, the optical fibers and the tape are closely contacted. For this reason, there is no margin of taking the optical fibers in and out at the terminal, and it is necessary to strictly adjust a length of the optical fiber when mounting the connector, for example. Also, it takes time to perform the adjustment or correction. Alternatively, the yields may be lowered. Due to these factors, the efficiency of the mounting operation and the like of the connector at the terminal is poor.

### SUMMARY

Exemplary embodiments of the present invention provide a photoelectric composite cable and a method of manufacturing the photoelectric composite cable whereby it is possible to suppress the manufacturing cost of the photoelectric composite cable and to efficiently perform a mounting operation or the like of a connector at a cable terminal.

A photoelectric composite cable according to an exemplary embodiment, comprises:

an optical fiber unit comprising at least one optical fiber and a cylindrical member, the cylindrical member including a resin tape wrapped to cover a periphery of the optical fiber, the resin tape being loosely wrapped with respect to the optical fiber;

a plurality of electric wires arranged on an outer side of the cylindrical member; and

a sheath covering outer peripheries of the optical fiber unit and the electric wires.

A method of manufacturing a photoelectric composite cable comprising an optical fiber unit comprising at least one optical fiber, a plurality of electric wires, and a sheath configured to cover outer peripheries of the optical fiber unit and the electric wires, according to an exemplary embodiment, the method comprises:

forming the optical fiber unit by wrapping a resin tape around the optical fiber while traveling the optical fiber, and traveling the optical fiber unit while applying a tensile force to the optical fiber unit; and

stranding the electric wires around the optical fiber unit being traveled, and traveling the optical fiber unit having the electric wires stranded thereon while applying a tensile force to the optical fiber unit having the electric wires stranded thereon,

wherein the tensile force that is applied to the optical fiber unit is greater than the tensile force that is applied to the optical fiber unit having the electric wires stranded thereon.

According to the present invention, it is possible to suppress the manufacturing cost of the photoelectric composite cable and to efficiently perform the mounting operation or the like of the connector at the cable terminal.

### BRIEF DESCRIPTION OF THE DRAWINGS

FIG. 1 is a sectional view of a photoelectric composite cable according to an exemplary embodiment.

FIG. 2 illustrates a wrapping tape that is to be wrapped on optical fibers.

FIG. 3 illustrates an example of electric wires to be stranded around an optical fiber unit.

FIG. 4 illustrates an example of an electric wire stranding method.

FIG. 5 illustrates another example of the electric wire stranding method.

FIG. 6 illustrates an example of the electric wires to be arranged around the optical fiber unit.

FIG. 7 illustrates operability of tape wrapping of the related art.

FIG. 8 illustrates operability of tape wrapping of the exemplary embodiment.

FIG. 9 depicts an example of a manufacturing apparatus of the photoelectric composite cable.

FIG. 10 depicts an example of a cage and bobbins configured to deliver electric wires and fillers.

FIG. 11 depicts another example of the cage and the bobbins.

FIG. 12 depicts another example of the cage and the bobbins.

### DETAILED DESCRIPTION

(Description of Exemplary Embodiment of Present Invention)

First, an exemplary embodiment of the present invention is described.

(1) A photoelectric composite cable comprises:

an optical fiber unit comprising at least one optical fiber and a cylindrical member, the cylindrical member including a resin tape wrapped to cover a periphery of the optical fiber, the resin tape being loosely wrapped with respect to the optical fiber;

a plurality of electric wires arranged on an outer side of the cylindrical member; and

a sheath covering outer peripheries of the optical fiber unit and the electric wires.

According to the above configuration, the electric wires are arranged on the outer side of the cylindrical member consisting of the resin tape wrapped to cover the periphery of the optical fiber, so that it is possible to separate the optical fiber and the electric wires from each other without using a tube. Since it is not necessary to form the tube by the extrusion molding, it is possible to suppress the manufacturing cost of the photoelectric composite cable. Further, when the resin tape is loosely wrapped, it is possible to insert and take out the optical fiber by several mm upon terminal processing, so that it is possible to efficiently perform a mounting operation or the like of a connector at a cable terminal.

(2) The optical fiber unit may comprise a tensile linear member arranged in the cylindrical member.

According to the above configuration, the tensile linear member is provided in the optical fiber unit, so that it is possible to secure the tensile strength of the entire photoelectric composite cable.

(3) The resin tape may be formed of polyethylene terephthalate.

According to the above configuration, since the resin tape formed of polyethylene terephthalate has strength enough to configure the optical fiber unit and is a material that is generally used as a constitutional material of a communication cable, it can be available at low cost.

(4) A thickness of the resin tape may be 50 μm to 500 μm.

According to the above configuration, the thickness of the resin tape formed of polyethylene terephthalate is set to 50 μm or greater, so that when taking out the optical fiber from the photoelectric composite cable, the optical fiber is naturally unwrapped by the rigidity of the wrapping tape, which contributes to the operability. Further, even when a predetermined level of tensile force is applied during the manufacturing, the resin tape is not broken, so that it is possible to perform the stable manufacturing. Also, the thickness of the wrapping tape is set to 500 μm or less, so that when wrapping the resin tape around the optical fiber, the resin tape can be formed into a cylindrical member shape without applying the excessive tensile force, which also contributes to the stable manufacturing.

(5) The electric wires may be stranded with untwisted lay around the optical fiber unit.

According to the above configuration, the electric wires are collected with untwisted lay, so that the twisting strain does not remain in the electric wires. Therefore, it is possible to flexibly bend the photoelectric composite cable.

(6) The electric wires may be stranded around the optical fiber unit with twisted lay.

According to the above configuration, the electric wires are collected with twisted lay, so that the electric wires tend to be spread outward. For this reason, a gap is formed around the optical fiber unit, so that the resin tape is spread. Thereby, a margin is formed for a space in the optical fiber unit, so that it is possible to easily take in and out the optical fibers. Therefore, it is possible to easily mount the connector to the cable terminal.

(7) The electric wires may be straightly arranged around the optical fiber unit.

According to the above configuration, the electric wires are straightly collected, so that it is not necessary to configure a collection facility, as a cage rotation type. For this reason, it is possible to save the facility cost.

(8) A method of manufacturing a photoelectric composite cable comprising an optical fiber unit comprising at least one optical fiber, a plurality of electric wires, and a sheath configured to cover outer peripheries of the optical fiber unit and the electric wires, the method comprises:

forming the optical fiber unit by wrapping a resin tape around the optical fiber while traveling the optical fiber, and traveling the optical fiber unit while applying a tensile force to the optical fiber unit; and

stranding the electric wires around the optical fiber unit being traveled, and traveling the optical fiber unit having the electric wires stranded thereon while applying a tensile force to the optical fiber unit having the electric wires stranded thereon,

wherein the tensile force that is applied to the optical fiber unit is greater than the tensile force that is applied to the optical fiber unit having the electric wires stranded thereon.

According to the above method, the resin tape is wrapped around the optical fiber, and the electric wires are stranded on the outer side of the resin tape. Thereby, it is possible to configure a structure by which it is possible to separate the optical fiber and the electric wires without using a tube. Since a process of forming a tube by the extrusion molding is not required, it is possible to suppress the manufacturing cost of the photoelectric composite cable. When wrapping the resin tape onto the optical fiber to form the optical fiber unit in the unit formation process, the appropriate tensile force is applied to the resin tape, so that it is possible to perform the wrapping while making a pitch and an overlapping width constant. Then, the tensile force that is applied to the optical fiber unit having the electric wires stranded thereon in the stranding process is set lower than the tensile force that is applied to the optical fiber unit in the unit formation process. Thereby, the wrapping of the resin tape becomes loose and a margin is formed for the space in the resin tape, so that it is possible to implement an appropriately loose state. When the resin tape is loosely wrapped in this way, it is possible to take in and out the optical fibers by several mm upon the terminal processing, so that it is possible to efficiently mount the connector to the cable terminal.

(Details of Exemplary Embodiment of Present Invention)

A specific example of the photoelectric composite cable and the method of manufacturing a photoelectric composite cable according to the exemplary embodiment of the present invention will be described with reference to the drawings.

In the meantime, the present invention is not limited to the example, is defined in the claims and is intended to include all changes within the scope and meaning equivalent to the claims.

In the descriptions of the exemplary embodiment, the term ‘parallel’ does not mean ‘parallel’ in a strict sense, and rather this term has a width within the scope of the present invention to achieve the effects inasmuch as it is within a range regarded as ‘parallel’. Also, the term ‘equal interval’ does not mean ‘equal interval’ in a strict sense, and rather this term has a width within the scope of the present invention to achieve the effects inasmuch as it is within a range regarded as ‘equal interval’.

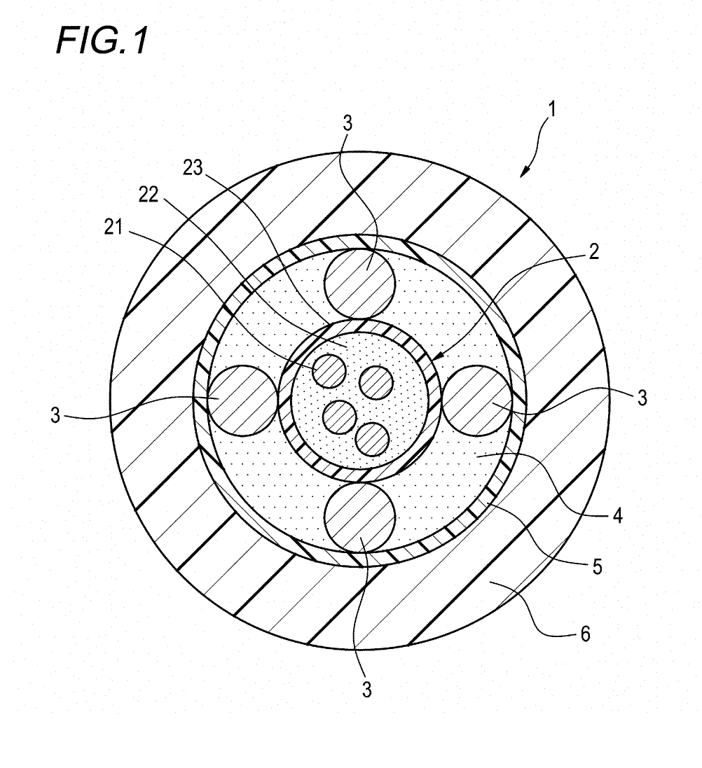

FIG. 1 depicts an example of a photoelectric composite cable. As shown in FIG. 1, a photoelectric composite cable 1 includes an optical fiber unit 2, one or more electric wires 3 (four, in this example), fillers 4, a wrapping tape 5, and a sheath 6.

The optical fiber unit 2 is arranged along a central axis of the photoelectric composite cable 1 so as to pass a central part of the photoelectric composite cable 1, in a cross sectional view. The optical fiber unit 2 includes one or more optical fibers 21 (four, in this example), tensile fibers 22 (an example of the linear member) provided to cover a periphery of the optical fibers 21, and a wrapping tape 23 wrapped to cover a periphery of the tensile fibers 22.

As the optical fiber 21, an all-silica fiber of which a core and a cladding are made of glass, a hard plastic clad fiber of which a core is made of glass and a cladding is made of resin, or the like is used.

The tensile fibers 22 are arranged on outer peripheries of the optical fibers 21 along the optical fibers 21. As the tensile fiber 22, a tensile aramid fiber such as Kevlar (registered trademark) is used. An amount of the tensile fibers 22 to be used is 1000 denier to 10000 denier, for example.

The wrapping tape 23 is wrapped into a cylindrical member shape so as to cover the tensile fibers 22 between the tensile fibers 22 and the four electric wires 3. The wrapping tape 23 is loosely wrapped with respect to the four optical fibers 21 arranged inside the cylindrical member of the wrapping tape 23. The description “loosely wrapped” means that when the four optical fibers 21 are collected to contact each other and the tensile fibers 22 are tightly packed around the optical fibers, the wrapping tape is wrapped so that an inner diameter of the wrapping tape 23 having the cylindrical member shape is larger than a diameter of an outer periphery of the tightly packed tensile fibers 22.

Since the wrapping tape 23 is loosely wrapped, the four optical fibers 21 arranged inside the cylindrical member can independently move in the cylindrical member, respectively, even though they are covered by the tensile fibers 22. As the wrapping tape 23, a resin tape such as a polyethylene terephthalate tape having excellent heat resistance and abrasion resistance, for example. A thickness of the wrapping tape 23 is 50 μm to 500 μm.

The wrapping tape 23 is provided, so that it is possible to suppress an increase in transmission loss, which may be caused as the optical fibers 21 are interposed between the plurality of electric wires 3. Also, it is possible to prevent a situation where the optical fibers 21 are slightly bent due to contact with the electric wires 3 and thus the transmission loss increases.

The electric wires 3 are arranged on an outer side of the wrapping tape 23 having the cylindrical member shape, i.e., on an outer side of the optical fiber unit 2. The respective electric wires 3 are arranged with equal intervals in a circumferential direction of the optical fiber unit 2, in a cross sectional view. As the electric wire 3, a coaxial wire having an insulating wire configured to cover a conductor with a sheath, a shield layer configured to cover an outer periphery of the insulating wire, and a protective film may be used. In addition to the coaxial wire, an insulating wire configured to cover a conductor with a sheath may be used as a power feeding wire or a ground wire.

The fillers 4 are arranged on the outer side of the optical fiber unit 2, like the electric wires 3. The fillers 4 are arranged between the electric wires 3 arranged with intervals. As the filler 4, PP yarn made of polypropylene for which a low shrinkage treatment has been performed, or the like is used.

The wrapping tape 5 is arranged on outer sides of the electric wires 3 and the fillers 4, and is configured to wrap the electric wires 3, the fillers 4, and the optical fiber unit 2. As the wrapping tape 5, a tape similar to the wrapping tape 23 may be used.

The sheath 6 is provided to cover an outer periphery of the wrapping tape 5, i.e., to cover outer peripheries of the optical fiber unit 2 and the electric wires 3. As the sheath 6, polyvinyl chloride or polyolefin-based resin or the like is used, for example. A thickness of the sheath 6 is 0.3 mm to 1.5 mm.

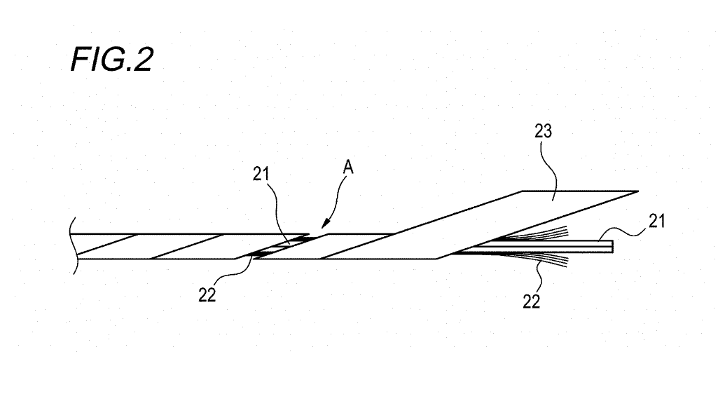

FIG. 2 depicts an example of a method of wrapping the wrapping tape 23 on the optical fibers 21.

As shown in FIG. 2, the wrapping tape 23 is spirally wrapped to cover a periphery of the optical fibers 21 and the tensile fibers 22. Herein, the description “cover a periphery” includes a configuration where when the wrapping tape 23 is wrapped, the optical fibers 21 and the tensile fibers 22 arranged in the wrapping tape 23 are covered without gaps so that the optical fibers and the tensile fibers are not to be seen from an outside. Also, the description “cover a periphery” may include a configuration where the wrapping tape 23 is not overlapped with each other and a slight gap is caused due to variability of a wrapping pitch of the wrapping tape 23, as shown with an arrow A in FIG. 2, and the optical fibers 21 and the tensile fibers 22 arranged inside the wrapping tape are covered with being visible from an outside.

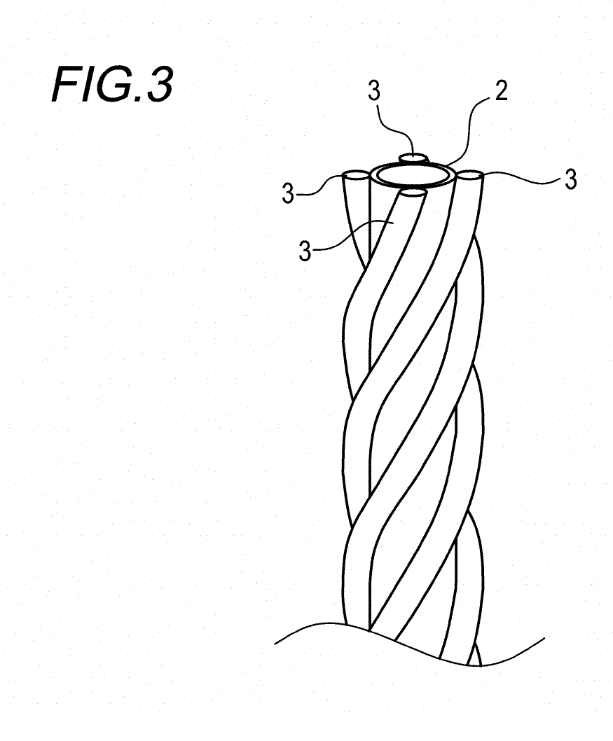

FIG. 3 is a perspective view depicting an example of the electric wires 3 to be arranged on the outer side of the optical fiber unit 2.

As shown in FIG. 3, the four electric wires 3 are arranged with being stranded around the optical fiber unit 2. The respective electric wires 3 are stranded at a state where distances between the electric wires are kept with equal intervals.

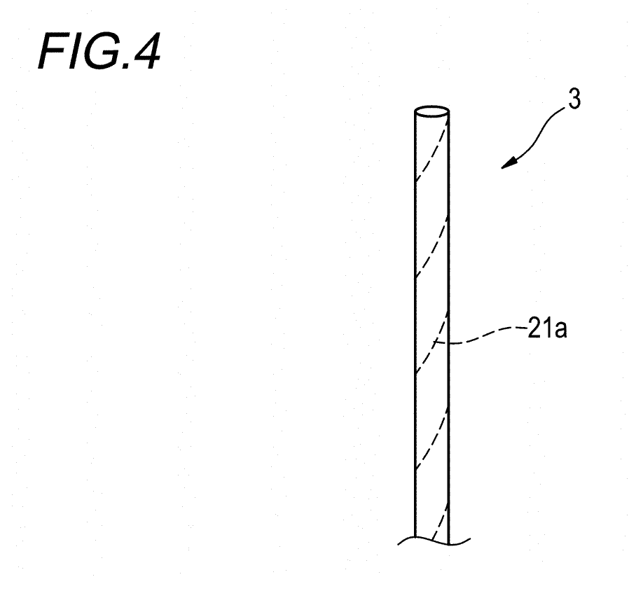

The electric wires 3 are stranded on the optical fiber unit 2 with untwisted lay. Herein, the description “with untwisted lay” means that the respective electric wires 3 are stranded around the optical fiber unit 2 with being twisted in a longitudinal direction of the electric wire 3. The description “with being twisted” means a stranding method where when the electric wires 3 are stranded around the optical fiber unit 2, a contact point locus of the electric wire 3 in contact with an outer peripheral surface of the optical fiber unit 2 becomes a line depicting a spiral line on the outer periphery of the straight electric wire 3, as shown with a dotted line 21a in FIG. 4.

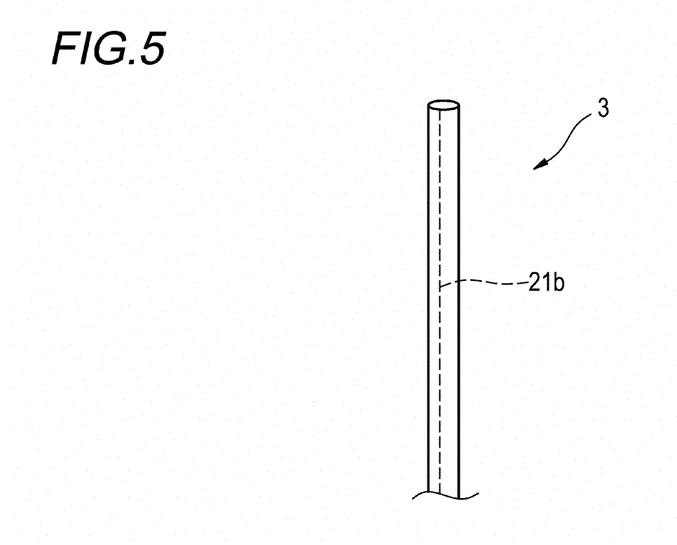

The electric wire 3 may be stranded on the optical fiber unit 2 with twisted lay. Herein, the description “with twisted lay” means that the respective electric wires 3 are stranded around the optical fiber unit 2 without being twisted in the longitudinal direction of the electric wire 3. The description “without being twisted” means a stranding method where when the electric wires 3 are stranded around the optical fiber unit 2, a contact point locus of the electric wire 3 in contact with the outer peripheral surface of the optical fiber unit 2 becomes a line depicting one straight line parallel with a central axis on the outer periphery of the straight electric wire 3, as shown with a dotted line 21b in FIG. 5.

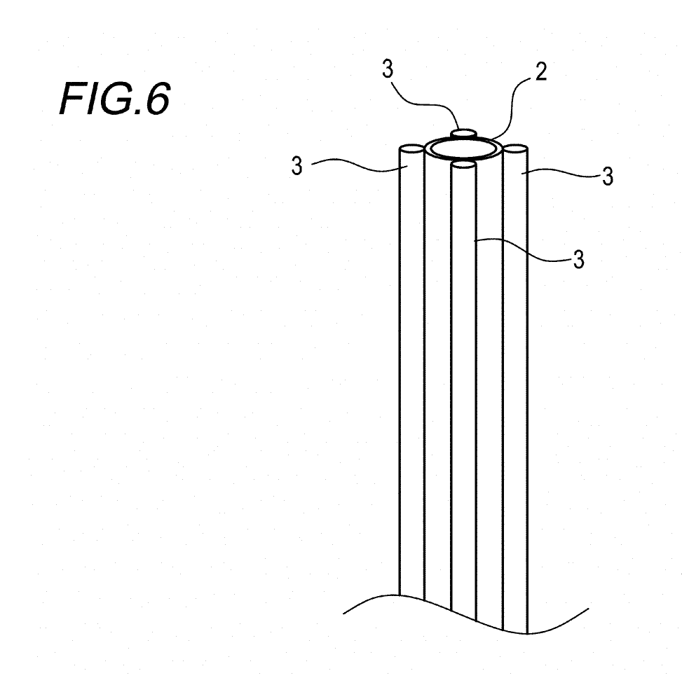

As shown in FIG. 6, the four electric wires 3 may be straightly arranged around the optical fiber unit 2. The respective electric wires 3 are arranged along the longitudinal direction of the optical fiber unit 2, i.e., are arranged so that a central axis of the optical fiber unit 2 and a central axis of the electric wire 3 are parallel with each other. Also, the respective electric wires 3 are arranged around the optical fiber unit 2 so that the distances between the electric wires are equal.

According to the photoelectric composite cable 1, the electric wires 3 are arranged on the outer side of the cylindrical member consisting of the wrapping tape 23 wrapped to cover the periphery of the optical fiber 21, so that it is possible to separate the optical fibers 21 and the electric wires 3 without using a resin tube. For this reason, since it is not necessary to form a resin tube by the extrusion molding, it is possible to suppress the manufacturing cost of the photoelectric composite cable.

In some cases, a cable having a connector configured to connect and to perform communication with a device is manufactured by mounting a connector to the photoelectric composite cable at its cable terminal. The connector has a circuit board, a photoelectric conversion element, a lens component or the like embedded therein. In this case, a distance from the cable terminal to the lens component or the like is determined by a design of the cable having a connector.

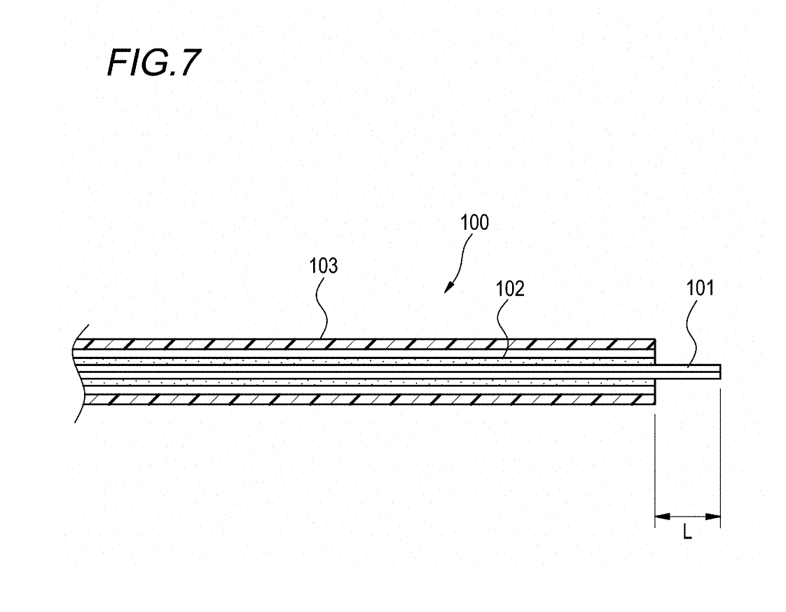

For example, in case of a photoelectric composite cable 100 of the related art having a configuration as shown in FIG. 7, optical fibers 101 are unitized with a wrapping tape 102 in a state that the optical fibers 101 are closely contacted by a wrapping tape 102. For this reason, when manufacturing a cable having a connector by using the photoelectric composite cable 100 of the related art, a sheath 103 and the wrapping tape 102 are removed by a length L (normally, several mm to about 10 mm) equivalent to a distance from the cable terminal to the lens component or the like, so that the optical fibers 101 are exposed. Then, the lens component or the like is mounted to the optical fibers 101 exposed by the length L. At this time, since the exposed portions of the optical fibers 101 are short, it is difficult to mount the lens component or the like embedded in the connector.

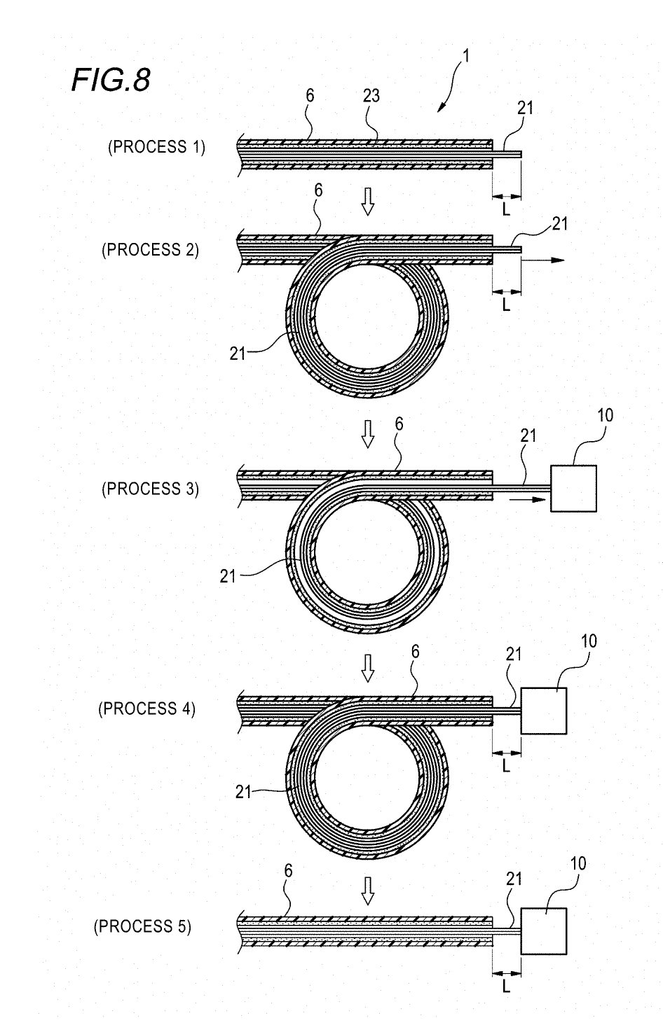

In contrast, when configuring a cable having a connector by using the photoelectric composite cable 1 of the exemplary embodiment, an operation is performed as shown in a series of operation processes of FIG. 8, so that it is possible to improve the operation efficiency of mounting the photoelectric composite cable 1 to the connector.

First, as shown in Process 1 of FIG. 8, the sheath 6 and the wrapping tape 23 of the photoelectric composite cable 1 are removed by the length L, so that the optical fibers 21 are exposed.

Then, as shown in Process 2 of FIG. 8, the photoelectric composite cable 1 is formed into a loop shape. As described above, the wrapping tape 23 is loosely wrapped into the cylindrical member shape, so that the optical fibers 21 are unitized to be independently moveable within the cylindrical member. For this reason, as shown in Process 3 of FIG. 8, the optical fibers 21 are inclined toward an inner side of the loop in the loosely wrapped wrapping tape 23 having the cylindrical member shape, so that the exposed portions of the optical fibers 21 can be further drawn longer than the length L on the order of several mm, in correspondence to the inclination.

Then, in the state of Process 3 of FIG. 8, the lens component or the like 10 is mounted to the drawn optical fibers 21. Since the exposed portions of the optical fibers 21 are longer than the length L on the order of several mm, it is possible to easily mount the lens component or the like 10. Then, as shown in Process 4 of FIG. 8, the optical fibers 21 are pressed to return the length of the exposed portions to the original length L. Then, as shown in Process 5 of FIG. 8, the photoelectric composite cable 1 having the loop shape is returned to its original state.

In this way, it is possible to efficiently mount the lens component or the like 10 embedded in the connector. Meanwhile, in FIGS. 7 and 8, the tensile fibers and the electric wires are omitted.

Like this, according to the photoelectric composite cable 1 of the exemplary embodiment, it is possible to efficiently mount the connector to the cable terminal while suppressing the manufacturing cost of the photoelectric composite cable 1.

Also, the tensile fibers 22 are provided in the optical fiber unit 2, so that it is possible to secure the high tensile strength of the entire photoelectric composite cable 1. The tensile fibers 22 having tensile strength are required to be straightly arranged in the photoelectric composite cable 1. In this regard, the tensile fibers are provided in the optical fiber unit 2, so that they can be straightly arranged. In the meantime, in case that the tensile fibers 22 are spirally stranded, the tensile fibers 22 may be tightened due to the stranding when the tensile force is applied thereto, so that the optical fibers 21 may be damaged. Also, the tensile fibers may be straightly arranged at a periphery of the photoelectric composite cable 1. In this case, however, the bending rigidity of the photoelectric composite cable 1 increases or the anisotropy is caused, so that the handling property may be deteriorated.

Also, since the wrapping tape 23 is formed of polyethylene terephthalate, it has the sufficient strength as a member configuring the optical fiber unit 2. In addition, since the wrapping tape is a material that is generally used as a constitutional material of a communication cable, it can be available at low cost.

Also, the thickness of the wrapping tape 23 formed of polyethylene terephthalate is set to 50 μm or greater, so that when taking out the optical fibers 21 from the photoelectric composite cable 1, the optical fibers 21 are naturally unwrapped by the rigidity of the wrapping tape 23, which contributes to the operability. Further, even when a predetermined level of tensile force is applied during the manufacturing, the wrapping tape 23 is not broken, so that it is possible to perform the stable manufacturing. Also, the thickness of the wrapping tape is set to 500 μm or less, so that when wrapping the wrapping tape around the optical fibers 21, the wrapping tape can be formed into the cylindrical member shape without applying the excessive tensile force, which also contributes to the stable manufacturing.

Furthermore, the electric wires 3 are stranded with untwisted lay, so that the twisting strain does not remain in the stranded electric wires 3. Therefore, it is possible to flexibly bend the photoelectric composite cable 1.

Also, when the electric wires 3 are stranded with twisted lay, the electric wires 3 tend to be spread outward from the stranded state. For this reason, a gap is formed around the optical fiber unit 2, so that the wrapping tape 23 having the cylindrical member shape is spread. Thereby, a margin is formed for a space in the optical fiber unit 2, so that it is possible to easily take in and out the optical fibers 21. Therefore, it is possible to easily mount the connector to the cable terminal.

Also, when arranging the electric wires 3 in the straight aspect, it is not necessary to configure a collection facility for collecting the electric wires 3 around the optical fiber unit 2 upon the manufacturing, as a cage rotation type. For this reason, it is possible to save the facility cost.

Subsequently, a method of manufacturing the photoelectric composite cable 1 is described.

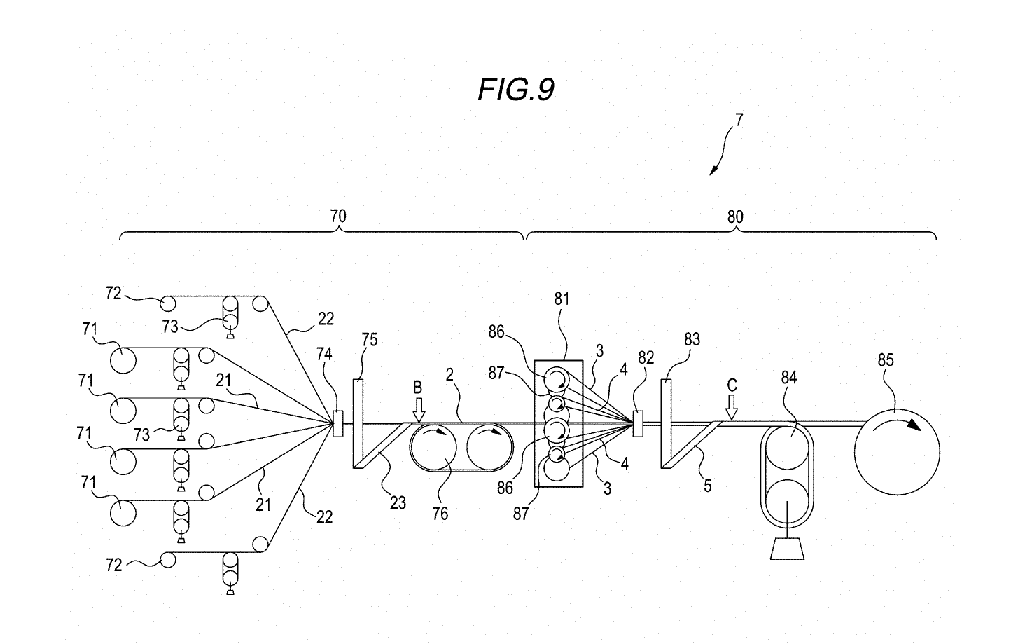

The photoelectric composite cable 1 can be manufactured using a manufacturing apparatus 7 as shown in FIG. 9, for example.

The manufacturing apparatus 7 includes a unit formation part 70 configured to form the optical fiber unit 2, and a stranding part 80 configured to strand the electric wires 3 on the optical fiber unit 2.

The unit formation part 70 includes fiber supplies 71, tensile fiber supplies 72, dancer rollers 73, a collection panel strip 74, a tape supply 75, and a mid-wheel capstan 76.

The fiber supplies 71 are configured to deliver the optical fibers 21 from bobbins. The tensile fiber supplies 72 are configured to deliver the tensile fibers 22 from bobbins. The dancer rollers 73 are configured to apply a predetermined tensile force to the delivered optical fibers 21 and tensile fibers 22, thereby removing the bending thereof. The collection panel strip 74 is configured to arrange the optical fibers 21 and the tensile fibers 22 at predetermined positions. The tape supply 75 is configured to deliver the wrapping tape 23 that is to be wrapped around the optical fibers 21 and the tensile fibers 22. The mid-wheel capstan 76 is configured to deliver the formed optical fiber unit 2 toward the stranding part 80.

The stranding part 80 includes a cage 81, a collection panel strip 82, a tape supply 83, dancer rollers 84, and a winding drum 85.

The cage 81 includes electric wire supplies 86 configured to deliver the electric wires 3 wound on bobbins, and filler supplies 87 configured to deliver the fillers 4 wound on bobbins. The collection panel strip 82 is configured to arrange the electric wires 3 and the fillers 4 at predetermined positions with respect to the optical fiber unit 2. The tape supply 83 is configured to deliver the wrapping tape 5 that is to be wrapped around the electric wires 3, the fillers 4, and the optical fiber unit 2. The dancer rollers 84 are configured to apply a predetermined tensile force to the optical fiber unit 2 having the wrapping tape 5 wrapped thereon, thereby removing the bending thereof. The winding drum 85 is configured to wind the optical fiber unit 2 having the wrapping tape 5 wrapped thereon.

In the unit formation part 70, a tensile force that is to be applied to the optical fiber unit 2 at a wrapping point B of the wrapping tape 23 is a sum of the supply tensile force, which is applied to the optical fibers 21 and the tensile fibers 22 from each dancer roller 73, and a longitudinal component of the supply tensile force of the wrapping tape 23. The summed tensile force is kept by the mid-wheel capstan 76.

In the stranding part 80, a tensile force that is to be applied to the optical fiber unit 2 having the wrapping tape 5 wrapped thereon at a wrapping point C of the wrapping tape 5 is a sum of the tensile force, which is applied by the dancer rollers 84, a supply tensile force of the electric wires 3 and the fillers 4, and a longitudinal component of the supply tensile force of the wrapping tape 5. The summed tensile force is kept by the dancer rollers 84.

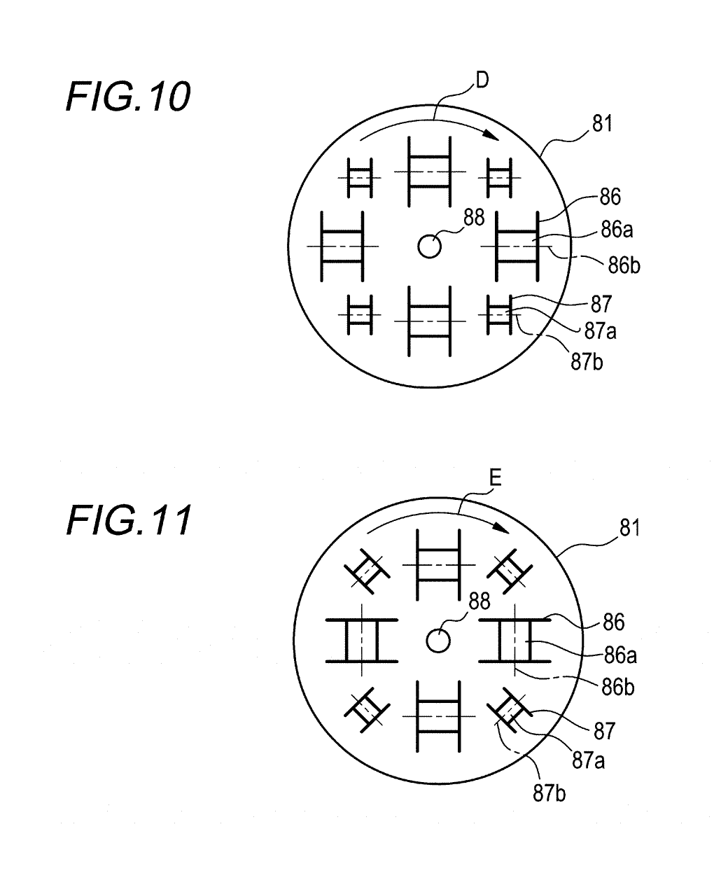

The cage 81, the electric wire supplies 86, and the filler supplies 87 of the stranding part 80 are configured as shown in FIGS. 10 to 12 by the stranding method of the electric wires 3 and the fillers 4 to be arranged around the optical fiber unit 2.

For example, when the electric wires 3 and the fillers 4 are stranded with untwisted lay around the optical fiber unit 2, the cage 81, the electric wire supplies 86, and the filler supplies 87 are configured as shown in FIG. 10, for example. FIG. 10 depicts the cage 81, as seen from the mid-wheel capstan 76 of FIG. 9.

The cage 81 is formed at its central portion with a passing hole 88 through which the optical fiber unit 2 is to pass. In the cage 81, bobbins 86a of the electric wire supplies 86 and bobbins 87a of the filler supplies 87 are arranged about the passing hole 88 so that respective rotary shafts 86b, 87b thereof are parallel. The bobbin 86a is configured to rotate about the rotary shaft 86b and to deliver the electric wire 3. The bobbin 87a is configured to rotate about the rotary shaft 87b and to deliver the filler 4. The cage 81 is configured to rotate about the passing hole 88 (the optical fiber unit 2) in a direction of an arrow D.

When manufacturing the photoelectric composite cable 1, all the bobbins (the bobbins 86a and the bobbins 87a) are rotated about the optical fiber unit 2 as the cage 81 is rotated. Thereby, while the delivery positions of the electric wires 3 or the fillers 4 are rotated, the electric wires 3 or the fillers 4 are delivered, so that the electric wires 3 and the fillers 4 are stranded around the optical fiber unit 2 (refer to FIG. 3). The rotary shafts 86b, 87b are all arranged in parallel with each other, so that even when the positions of the bobbins 86a, 87a are changed by the rotation of the cage 81, the directions of the rotary shaft 86b, 87b are not changed. Therefore, the electric wire 3 and fillers 4 stranded on the optical fiber unit 2 have untwisted lay with being twisted in the longitudinal direction (refer to FIG. 4).

Also, for example, when the electric wires 3 and the fillers 4 are stranded around the optical fiber unit 2 with twisted lay, the cage 81, the electric wire supplies 86, and the filler supplies 87 are configured as shown in FIG. 11, for example. FIG. 11 also depicts the cage 81, as seen from the mid-wheel capstan 76.

In the cage 81, the bobbins 86a and the bobbins 87a are arranged about the passing hole 88 so that the rotary shafts 86b of the bobbins 86a and the rotary shafts 87b of the bobbins 87a form a circular ring shape. The bobbin 86a is configured to rotate about the rotary shaft 86b and to deliver the electric wire 3. The bobbin 87a is configured to rotate about the rotary shaft 87b and to deliver the filler 4. The cage 81 is configured to rotate about the passing hole 88 (the optical fiber unit 2) in a direction of an arrow E.

When manufacturing the photoelectric composite cable 1, all the bobbins (the bobbins 86a and the bobbins 87a) are rotated about the optical fiber unit 2 as the cage 81 is rotated. Thereby, while the delivery positions of the electric wires 3 or the fillers 4 are rotated, the electric wires 3 or the fillers 4 are delivered, so that the electric wires 3 and the fillers 4 are stranded around the optical fiber unit 2 (refer to FIG. 3). The rotary shafts 86b, 87b are arranged to form a circular ring shape as shown in FIG. 11, so that when the positions of the bobbins 86a, 87a are changed by the rotation of the cage 81, the directions of the rotary shaft 86b, 87b are changed. Therefore, the electric wires 3 and fillers 4 stranded on the optical fiber unit 2 have twisted lay without being twisted in the longitudinal direction (refer to FIG. 5).

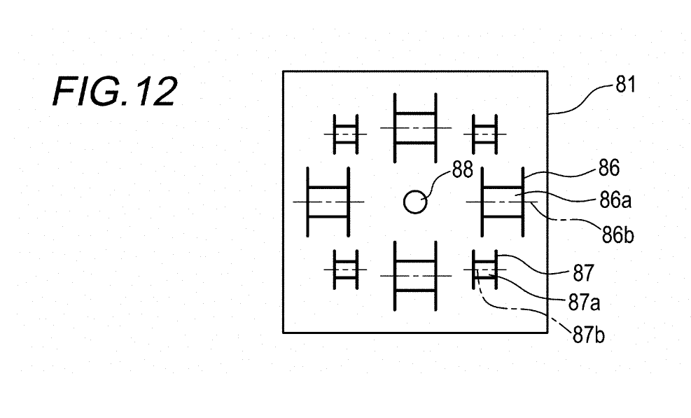

Also, for example, when the electric wires 3 and the fillers 4 are straightly arranged around the optical fiber unit 2, the cage 81, the electric wire supplies 86, and the filler supplies 87 are configured as shown in FIG. 12. FIG. 12 also depicts the cage 81, as seen from the mid-wheel capstan 76.

In the cage 81, the bobbins 86a and the bobbins 87a are arranged so that the rotary shafts 86b, 87b thereof are parallel with each other, like FIG. 10. The bobbin 86a is configured to rotate about the rotary shaft 86b and to deliver the electric wire 3. The bobbin 87a is configured to rotate about the rotary shaft 87b and to deliver the filler 4. In the meantime, the cage 81 is configured not to rotate.

When manufacturing the photoelectric composite cable 1, all the bobbins (the bobbins 86a and the bobbins 87a) deliver the electric wires 3 or the fillers 4 without changing the positions thereof. Thereby, the electric wires 3 and the fillers 4 are straightly arranged around the optical fiber unit 2 (refer to FIG. 6).

By the manufacturing apparatus 7 configured as described above, the photoelectric composite cable 1 is manufactured as follows.

First, the optical fibers 21 are delivered from the fiber supplies 71, and the tensile fibers 22 are delivered from the tensile fiber supplies 72. The optical fibers 21 and the tensile fibers 22 travel while the predetermined tensile force is being applied thereto by the respective dancer rollers 73. The optical fibers 21 and the tensile fibers 22 are aligned at predetermined positions by the collection panel strip 74, the aligned optical fibers 21 and tensile fibers 22 are loosely wrapped into a cylindrical member shape by the wrapping tape 23, so that the optical fiber unit 2 is formed. While the formed optical fiber unit 2 is applied with a predetermined tensile force T1 by the mid-wheel capstan 76, it continuously travels toward a next process (an example of the unit formation process).

Continuously, the electric wires 3 delivered from the electric wire supplies 86 of the cage 81 and the fillers 4 delivered from the filler supplies 87 are stranded around the optical fiber unit 2 traveling continuously from the unit formation process. The electric wires 3 and the fillers 4 are aligned at predetermined positions with respect to the optical fiber unit 2 by the collection panel strip 82, and the wrapping tape 5 is wrapped around the aligned optical fiber unit 2, electric wires 3, and fillers 4. The optical fiber unit 2 having the wrapping tape 5 wrapped thereon travels while being applied with a predetermined tensile force T2 by the dancer rollers 84. The optical fiber unit 2 having the wrapping tape 5 wrapped thereon is wound by the winding drum 85 (an example of the stranding process).

In the above example, the tensile force T1 that is applied to the optical fiber unit 2 at the wrapping point B (refer to FIG. 9) of the wrapping tape 23 is set greater than the tensile force T2 that is applied to the optical fiber unit 2 having the wrapping tape 5 wrapped thereon at the wrapping point C (refer to FIG. 9) of the wrapping tape 5.

According to the method of manufacturing a photoelectric composite cable, the wrapping tape 23 is wrapped around the optical fibers 21 and the tensile fibers 22, and the electric wires 3 are stranded on the outer side of the wrapping tape 23. Thereby, it is possible to configure a structure by which it is possible to separate the optical fibers 21 and the electric wires 3 without using a tube. For this reason, a separate process of forming a tube by the extrusion molding is not required, so that it is possible to suppress the manufacturing cost of the photoelectric composite cable 1.

Also, when wrapping the wrapping tape 23 onto the optical fiber 21 to form the optical fiber unit 2 in the unit formation process, the appropriate tensile force Ti is applied to the wrapping tape 23, so that it is possible to perform the wrapping while making the pitch and overlapping width of the wrapping tape 23 constant. Then, the tensile force T2 that is applied to the optical fiber unit 2 having the electric wires 3 stranded thereon in the stranding process is set lower than the tensile force T1 that is applied to the optical fiber unit 2 in the unit formation process. Thereby, the wrapping of the wrapping tape 23 becomes loose and a margin is formed for the space in the wrapping tape 23, so that it is possible to implement an appropriately loose state. When the wrapping tape 23 is loosely wrapped in this way, it is possible to take in and out the optical fibers 21 from the optical fiber unit 2 by several mm upon the terminal processing of the cable, so that it is possible to efficiently mount the connector to the cable terminal.

Although the present invention has been specifically described with reference to the specific exemplary embodiment, it is obvious to one skilled in the art that the exemplary embodiment can be diversely changed and modified without departing from the spirit and scope of the present invention. Also, the numbers, positions, shapes and the like of the constitutional members are not limited to the exemplary embodiment and can be changed to the favorable numbers, positions, shapes and the like when implementing the present invention.

What is claimed is:

1. A photoelectric composite cable comprising:
an optical fiber unit comprising at least one optical fiber and a cylindrical member, the cylindrical member including a resin tape wrapped to cover a periphery of the optical fiber, the resin tape being loosely wrapped with respect to the optical fiber;
a plurality of electric wires arranged on an outer side of the cylindrical member; and
a sheath covering outer peripheries of the optical fiber unit and the electric wires.

2. The photoelectric composite cable according to claim 1, wherein the optical fiber unit comprises a tensile linear member arranged in the cylindrical member.

3. The photoelectric composite cable according to claim 1, wherein the resin tape is formed of polyethylene terephthalate.

4. The photoelectric composite cable according to claim 3, wherein a thickness of the resin tape is 50 μm to 500 μm.

5. The photoelectric composite cable according to claim 1, wherein the electric wires are stranded with untwisted lay around the optical fiber unit.

6. The photoelectric composite cable according to claim 1, wherein the electric wires are stranded around the optical fiber unit with twisted lay.

7. The photoelectric composite cable according to claim 1, wherein the electric wires are straightly arranged around the optical fiber unit.

8. A method of manufacturing a photoelectric composite cable comprising an optical fiber unit comprising at least one optical fiber, a plurality of electric wires, and a sheath configured to cover outer peripheries of the optical fiber unit and the electric wires, the method comprising:
forming the optical fiber unit by wrapping a resin tape around the optical fiber while traveling the optical fiber, and traveling the optical fiber unit while applying a tensile force to the optical fiber unit; and
stranding the electric wires around the optical fiber unit being traveled, and traveling the optical fiber unit having the electric wires stranded thereon while applying a tensile force to the optical fiber unit having the electric wires stranded thereon,
wherein the tensile force that is applied to the optical fiber unit is greater than the tensile force that is applied to the optical fiber unit having the electric wires stranded thereon.
